(19) United States
(12) Patent Application Publication
(10) Pub. No.: US 2006/0013537 A1
(43) Pub. Date: Jan. 19, 2006

(54) Optical fiber connector-use ferrule an optical fiber connector structure, and ferrule connecting sleeve

(76) Inventors: Mikio Miyake, Tokyo (JP); Tetsuo Tanaka, Tokyo (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/517,248

(22) PCT Filed: Jun. 7, 2002
(86) PCT No.: PCT/JP02/05666

§ 371 Date: Jun. 20, 2005

(51) Int. Cl. G02B 6/38

(52) U.S. Cl. 385/60

(57) ABSTRACT

A pair of ferrules used for a fiber connector has a first ferrule 58a having an optical fiber-inserting hole, and a second ferrule 58b arranged opposite to, and on the same axis as, the first ferrule. The front portion of the first ferrule has a male convex shape, and the front portion of the second ferrule has a female concave shape provided with a fitting section for tightly receiving the male convex shaped structure. A sleeve 54 for connecting the two ferrules for optical fiber inside thereof includes a cylindrical sleeve main body, and a plurality of projections 54a provided on the inner circumferential surface of the main body for supporting the outer circumferential surfaces of the ferrules for optical fiber, the plurality of projections being provided to be rotary-symmetrical with respect to the central axis of the sleeve main body and having the identical height.

### TECHNICAL FIELD

The present invention relates to ferrules for an optical fiber connector, and an optical fiber connector structure which adopts the same ferrules. In particular, the present invention relates to ferrules for an optical fiber connector in which coupling sections are coupled easily and reliably between ends of optical fibers, and an optical fiber connector structure which adopts the same ferrules. The present invention also relates to a sleeve for connecting ferrules with which the two ferrules are connected to one another with highly accurate axial adjustment.

### BACKGROUND ART

Optical fibers are widely used, for example, for optical communication, optical devices, equipment for LAN, and various optical communication systems. When optical fibers are connected to one another in such an optical communication system, a detachable connecting system, which is based on an optical fiber connector, is adopted. A ferrule coupling structure, which is adopted in the conventional optical fiber connector, is constructed as illustrated in a sectional view shown in FIG. 6. That is, in FIG. 6, reference numerals 2A, 2B indicate left and right ferrules, and 3A, 3B indicate left and right flange-equipped cylinders. Optical fiber-inserting holes 1a, 1b formed through the ferrules 2A, 2B and optical fiber-introducing holes 1c, 1d formed through the flange-equipped cylinders 3 are continued along the optical axis. The outer circumferential portions of the ferrules 2A, 2B, which are disposed in the vicinity of the joined portions of the ferrules 2A, 2B, are protected by a split sleeve 4. Optical fibers 1, 1′ are inserted until arrival at the optical fiber-inserting holes 1a, 1b of the ferrules 2A, 2B through the optical fiber-introducing holes 1c, 1d of the flange-equipped cylinders 3A, 3B.

In order to decrease the reflection loss at the connecting portion when the optical fibers are connected to one another by using the optical fiber connector, the connection in which the tips of the optical fibers are allowed to make mutual abutment, i.e., the so-called physical contact (hereinafter referred to as “PC”) connection is carried out. In order to achieve the PC connection, the following process has been performed. That is, the end surface of the ferrule is polished into a convex spherical surface or an oblique convex spherical surface, or the end surface of the ferrule is polished into a flat surface or an oblique flat surface simultaneously with the tip of the optical fiber in a state in which the optical fiber is charged to the ferrule. However, in the case of the conventional ferrule composed of, for example, zirconia or glass, a problem arises such that the process as described above cannot be performed with ease as well.

In the conventional technique, the following procedure has been adopted for the fiber cable for the optical communication, because it is necessary that the mutual core deviation, which is caused at the connecting portion, is suppressed to be not more than several μm. That is, the connector is installed to the end of the optical fiber, and the end surfaces of the both are polished. The tips of the fibers are connected to one another by the forcible abutment. However, a problem arises such that the positioning of the ferrule is incorrect, and the accuracy of the fiber connection is not improved.

Further, the ferrule is produced as follows. That is, a raw material, which is obtained by mixing an appropriate binder with ceramic particles such as zirconia and alumina or metal particles such as stainless steel or the like, is subjected to the injection molding to have a predetermined shape, followed by being sintered. Therefore, the fluidity of the molding material is low, and it has been difficult to charge the molding material until arrival at the end surface during the injection molding.

In view of the above, the following procedure has been hitherto performed. That is, the injection molding is performed to provide an outer diameter which is larger than an outer diameter as the ferrule. The outer diameter is polished after the sintering of the formed product so that the product is finished to have the predetermined diameter as the ferrule.

In the forming method as described above, the obtained sintered product is somewhat shrunk and deformed due to the sintering, and the inner diameter is deviated from a desired size. Therefore, the polishing for the sintered product, in which a columnar through-hole is polished by using a diamond polishing member, has been a necessary and indispensable process.

However, the polishing operation is extremely laborious and it requires the skill, because the sintered product is composed of the ceramic which is hard. The polishing operation has caused the decrease in the productivity.

Further, it has not been easy to completely uniformize the inner diameter at positions in the axial direction of the inner hole of the sintered product even when the polishing is performed, for example, because the diamond is applied in any nonuniform situation for the linear polishing member. Further, the expensive diamond polishing member is exhausted. Therefore, a problem arises such that the equipment cost is expensive.

Further, in order to perform the injection molding or the extrusion molding as described above, it is necessary to prepare a molding or forming machine and a mold or a die which are expensive and exclusive. In particular, the forming machine and the die are conspicuously abraded by the zirconia powder which is extremely hard. Therefore, the service life is short as well. It is also possible to use hard materials for the surfaces of the forming machine and the die. However, the cost is extremely expensive for such a forming machine and such a die which are to be specially prepared. Further, the sintering is performed at a high temperature of about 1,200° C. during the sintering step. Therefore, the energy cost is expensive, and the energy resource is wasted as well.

Further, in the case of the production of the ferrule based on the conventional technique, it has been almost impossible to manufacture a linear thin hole having a high circularity with a length of not less than 8 mm and an inner diameter of not more than 125 μm.

### DISCLOSURE OF THE INVENTION

The present invention has been made in order to solve the problems as described above, an object of which is to provide a pair of ferrules with which ends of optical fibers are coupled to one another at a coupling portion easily and reliably, an optical fiber connector structure which adopts the same ferrules, and a sleeve for connecting ferrules which connects the two ferrules with more highly accurate axial adjustment.

According to a first aspect of the present invention, there are provided a pair of ferrules used for an optical fiber connector, the pair of ferrules comprising:

a first ferrule which has an optical fiber-inserting hole; and

a second ferrule which has an optical fiber-inserting hole and which is arranged opposingly to the first ferrule so that the optical fiber-inserting hole of the second ferrule is positioned coaxially with respect to the optical fiber-inserting hole of the first ferrule, wherein:

an end of the first ferrule, which is opposed to the second ferrule, has a male convex shape, and an end of the second ferrule, which is opposed to the first ferrule, has a female concave shape provided with a fitting section for receiving the end having the male convex shape while making tight contact therewith.

According to a second aspect of the present invention, there are provided a pair of ferrules used for an optical fiber connector, the pair of ferrules comprising:

a first ferrule which has an optical fiber-inserting hole; and

a second ferrule which has an optical fiber-inserting hole and which is arranged opposingly to the first ferrule so that the optical fiber-inserting hole of the second ferrule is positioned coaxially with respect to the optical fiber-inserting hole of the first ferrule, wherein:

an end of the first ferrule, which is opposed to the second ferrule, has a male convex shape, an end of the second ferrule, which is opposed to the first ferrule, has a female concave shape provided with a fitting section for receiving the end having the male convex shape while making tight contact therewith, a base section of the end having the male convex shape is continued to an end edge of an annular step which is formed to have a diameter reduced in a radial direction of the ferrule, and a base section of the end having the female concave shape is continued to an end edge of an annular step which is formed to have a diameter reduced in a radial direction at an open end of the ferrule.

According to a third aspect of the present invention, there is provided an optical fiber connector structure comprising:

a first ferrule which has an optical fiber-inserting hole;

a second ferrule which has an optical fiber-inserting hole and which is arranged opposingly to the first ferrule so that the optical fiber-inserting hole of the second ferrule is positioned coaxially with respect to the optical fiber-inserting hole of the first ferrule;

a protective sleeve which covers the ferrules; and

flange-equipped cylinders each of which has an optical fiber-introducing hole and each of which is provided and fitted on a proximal end side of each of the ferrules, wherein:

an end of the first ferrule, which is opposed to the second ferrule, has a male convex shape, and an end of the second ferrule, which is opposed to the first ferrule, has a female concave shape provided with a fitting section for receiving the end having the male convex shape while making tight contact therewith.

In the first to third aspects, each of the end having the male convex shape and the end having the female concave shape may have one of a conical shape, a hemispherical shape, and a spheroidal shape. When the end having the male convex shape of the first ferrule is conical, the cone may have an angle of depression of 20 to 80° and preferably 30 to 60°. Each of the first and second ferrules may be made of metal, especially nickel alloy or stainless steel. Each of the first and second ferrules may be produced by an electroforming method.

According to a fourth aspect of the present invention, there is provided a sleeve for connecting two optical fiber ferrules therein, comprising:

a cylindrical sleeve main body; and

a plurality of projections which are provided on an inner circumferential surface of the main body and which support outer circumferential surfaces of the the optical fiber ferrules, wherein:

the plurality of projections are provided at positions of rotational symmetry with respect to a central axis of the sleeve main body and have an identical height. The projection may have a tapered shape toward the central axis of the sleeve main body. The sleeve may be formed by electroforming. The projections may extend in parallel to the central axis of the sleeve main body. Three of the projections may be formed at positions of rotational symmetry at intervals of 120°.

According to a fifth aspect of the present invention, there is provided a method for producing the sleeve, comprising:

forming a plurality of cutouts at positions of rotational symmetry on an outer circumferential surface of a core wire, the plurality of cutouts extending in a longitudinal direction of the core wire;

forming a metal film by electroforming around the core wire formed with the plurality of cutouts; and

removing the core wire from the metal film. The core wire may be removed by extrusion and/or extraction. The core wire may be extruded from the metal film by bringing a pressurized fluid into contact with the metal film or the core wire. According to the method of the present invention, the sleeve is formed by the electroforming. Therefore, the size of the projection formed in the sleeve is determined by the size accuracy of the cutout formed on the core wire. Therefore, for example, the projection, which has an accuracy of 1.25±0.02 μm, can be formed in the longitudinal direction of the sleeve.

### BRIEF DESCRIPTION OF THE DRAWINGS

FIG. 1(a) shows a sectional view illustrating a ferrule according to the present invention, FIG. 1(b) shows a perspective view illustrating the same ferrule, and FIG. 1(c) shows a front view illustrating the angle-of inclination of a conical shape disposed at a front portion of the same ferrule.

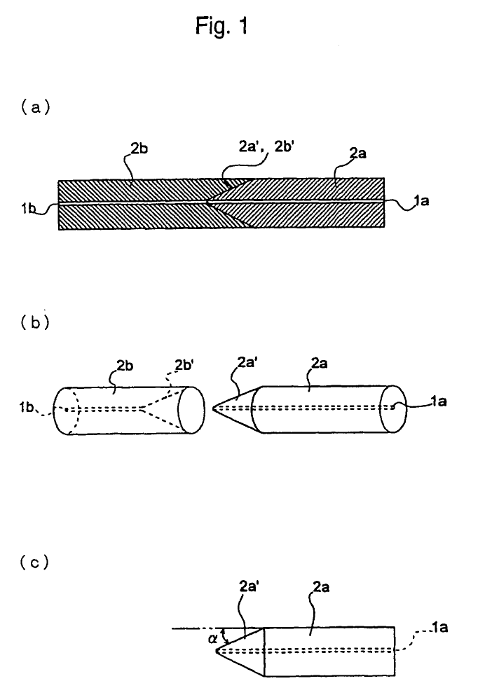

FIG. 2(a) shows a sectional view illustrating a case in which a ring-shaped stepped section is provided at a front portion of the ferrule shown in FIG. 1, and FIG. 2(b) shows a perspective view illustrating the same.

FIG. 3 shows a sectional view illustrating a state in which the ferrules are protected by a sleeve.

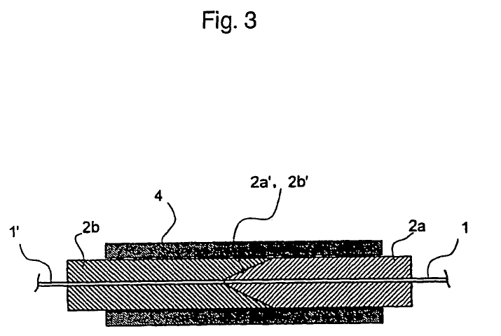

FIG. 4 shows a sectional view illustrating the ferrule coupling structure of an optical fiber connector of the present invention.

FIG. 5 illustrates the working operation for manufacturing the ferrules of the present invention, wherein FIG. 5(a) illustrates the operation for manufacturing a conical female concave structure, FIG. 5(b) illustrates the operation for manufacturing a conical male convex structure, and FIG. 5(c) shows a front view and a perspective view illustrating a bite preferably usable to manufacture a conical female concave structure having an annular step.

FIG. 6 shows a sectional view illustrating the ferrule coupling structure of the conventional optical fiber connector.

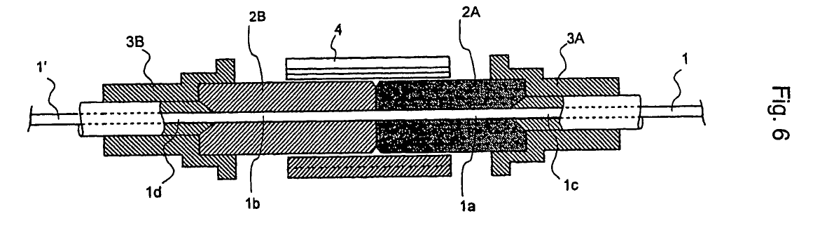

FIG. 7 schematically illustrates steps (a) to (d) of producing a protective sleeve for connecting and fixing the ferrules in a second embodiment of the present invention.

FIG. 8 schematically shows the protective sleeve produced in the second embodiment and a modified embodiment thereof, wherein FIG. 8(a) shows a sectional view, FIG. 8(b) shows a perspective view, and FIG. 8(c) shows a sectional view illustrating the another embodiment.

FIG. 9 shows a sectional view illustrating an example of the ferrule coupling structure based on the use of the protective sleeve produced in the second embodiment.

### BEST MODE FOE CARRYING OUT THE INVENTION

Embodiments of the present invention will be explained on the basis of the drawings.

### First Embodiment

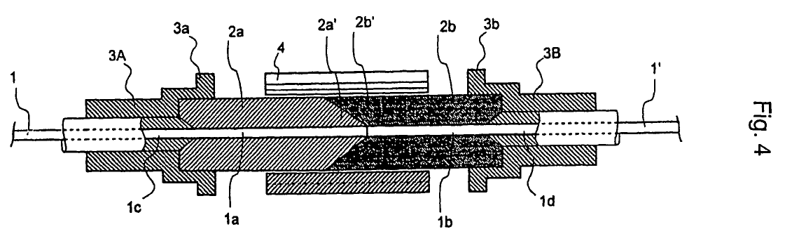

The ferrule coupling structure of the optical fiber connector of the present invention is constructed as illustrated in a sectional view shown in FIG. 4.

That is, with reference to FIG. 4, reference numerals 2a, 2a indicate left and right ferrules (preferably made of electroformed nickel alloy), and 3A, 3B indicate left and right flange-equipped cylinders. Optical fiber-inserting holes 1a, 1b formed through the ferrules 2a, 2b and optical fiber-introducing holes 1c, 1d formed through the flange-equipped cylinders 3A, 3B are continued along the optical axis. The outer circumferential portions of the ferrules 2a, 2b, which are disposed in the vicinity of the joined portions of the ferrules 2a, 2b, are protected by a split sleeve 4. In this embodiment, front sections 2a′, 2b′ of the ferrules 2a, 2b have a conical male convex structure and a conical female concave structure respectively. Optical fibers 1, 1′ are inserted until arrival at the optical fiber-inserting holes 1a, 1b of the ferrules 2a, 2b through the optical fiber-introducing holes 1c, 1d of the flange-equipped cylinders 3A, 3B.

The flange-equipped cylinders 3A, 3B are usually cylinders made of metal, and square flanges 3a, 3b are formed on the outer circumferences on the tip sides. Ferrule-fitting sections, which have inner diameters in conformity with the outer diameters of the ferrules 2a, 2b, are formed at central portions of the square flanges 3a, 3b. The tips of the flange-equipped cylinders 3A, 3B are fitted to the outer circumferences of the ferrules 2a, 2b on the proximal end sides. The ferrules 2a, 2b and the flange-equipped cylinders 3A, 3B are continued along the optical axis.

That is, the optical fiber-inserting holes, which are communicated with the ferrule-fitting sections, are formed along the central axis (optical axis) of the cylindrical portions of the flange-equipped cylinders 3A, 3B. As a result, the optical fiber-inserting holes 1a, 1b of the ferrules 2a, 2b to which the ferrule-fitting sections are fitted are communicated with the optical fiber-inserting holes 1c, 1d.

The ferrule of the present invention is preferably manufactured by the electroforming method. The production of the ferrule based on the electroforming method has been previously developed by the inventors, details of which are disclosed in WO 00/31574 of the inventors and U.S. patent application Ser. No. 09/449,999 corresponding thereto (registration fee has been already paid). U.S. patent application Ser. No. 09/449,999 is incorporated herein by reference within a range of permission of the domestic laws and ordinances of the designated state and the selected state.

The ferrule is produced as follows. That is, an electrode thin wire, which is stretched in a nickel ion-based electroforming solution, is rotated, and a nickel-based metal is deposited on the surface of the thin wire to form a thin tube made of the nickel-based metal for the ferrule on the electrode thin wire.

In order to change the hardness of the ferrule, for example, the composition of the electroforming solution is changed at the stage at which the nickel-based metal (nickel alloy) is deposited by the electroforming method so that the alloy composition is changed between the inner portion and the surface layer portion. Thus, the change of the hardness of the ferrule can be carried out. Alternatively, the nickel-based electroformed thin wire is exposed-to a nitrogen gas atmosphere at a high temperature, and thus the nitriding treatment is performed so that the surface layer portion has a high hardness.

The coupling state as the physical contact is preferably stabilized by providing the high hardness for the surface layer portion of the male convex structure rather than for the surface layer portion of the conical female concave structure, i.e., by decreasing the hardness for the surface layer portion of the female concave structure and increasing the hardness for the surface layer portion of the male convex structure to combine the both. The combined structure as described above does not cause any loosening as well during the use in a high vibration environment, which is an appropriate structure.

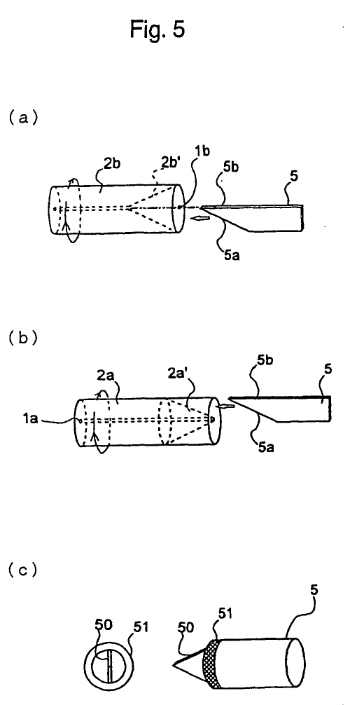

Next, the conical male convex structure and the female concave structure of the ferrules of the present invention can be formed, for example, as illustrated in FIG. 5.

FIG. 5(a) illustrates the production of the female concave structure, in which a cutter blade-shaped bite 5 made of diamond single crystal (the bite is provided with a blade section 5a having widths gradually reduced from the tip of a horizontal back section 5b) has its tip which is pressed horizontally toward an end thin hole 1b of the rotating ferrule 2b.

FIG. 5(b) illustrates the production of the male convex structure, in which a cutter blade-shaped bite 5 made of diamond single crystal (the bite is provided with a blade section 5a having widths gradually reduced from the tip of a horizontal back section 5b) has its tip which is pressed horizontally toward an outer circumferential edge end of the rotating ferrule. According to the above, the female concave structure and the male convex structure can be formed easily and reliably at the front portions of the ferrules.

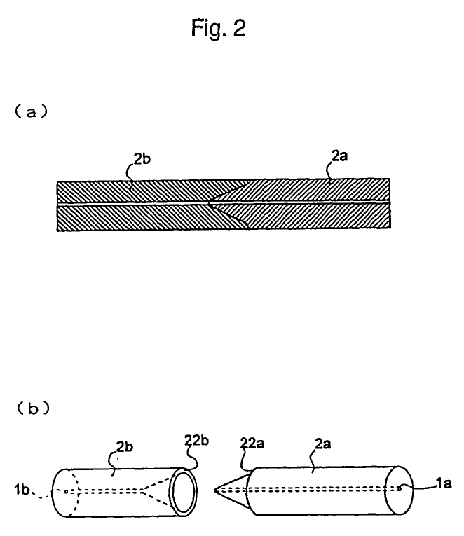

FIG. 5(c) shows a side view and a perspective view illustrating an exemplary bite for manufacturing a female concave structure having an annular step 22a, 22b. The bite is composed of an isosceles triangular blade section 50 made of diamond single crystal, and a pressing tool 51 for forming a ring-shaped stepped section secured to the base portion of the blade section 50. When the bite shown in FIG. 5(c) is pressed toward the end of the ferrule as shown in FIG. 5(a), it is possible to manufacture the ferrule provided with the stepped section as shown in FIG. 2.

The production of the ferrule has been explained above. When the optical fiber connector structure is assembled, the ferrules 2a, 2b are firstly inserted from the left and the right into the inside of the split sleeve 4. Accordingly, the conical male convex structure, which is disposed at the front section 2a′ of the ferrule 2a, is fitted and inserted correctly, smoothly, and easily into the conical female concave structure disposed at the front section 2b′ of the ferrule 2b as if the male convex structure automatically searches for the identical axis in accordance with the guiding action to make the abutment.

It is preferable that both of the surface of the conical male convex structure disposed at the front section 2a′ of the ferrule 2a and the inner surface of the conical female concave structure disposed at the front section 2b′ of the ferrule 2b are mirror-finished surfaces. When the both are the mirror-finished surfaces, any leakage light is collected to the center, even if the light leaks from the tip of 2a′. Thus, the light is sufficiently transmitted.

In the embodiment described above, the male convex structure and the female concave structure are formed to have the conical shapes to be fitted to one another. However, arbitrary shapes may be adopted provided that the shapes causes the mutual fitting. For example, it is also possible to provide spheroidal structures, hemispherical structures, dome-shaped structures, and pyramid-shaped structures such as trigonal pyramid-shaped structures and quadrangular pyramid-shaped structures. Alternatively, it is also allowable to adopt a columnar convex portion and a columnar concave portion which are to be fitted to one another.

### Second Embodiment

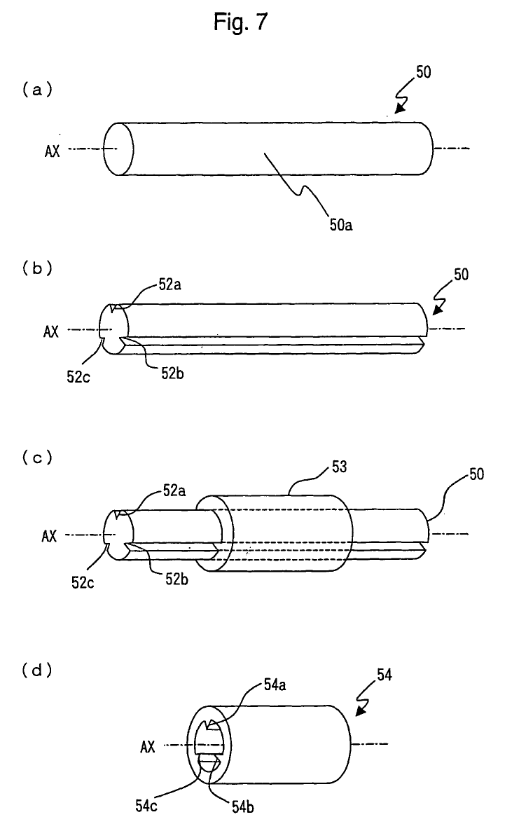

Next, an explanation will be made with reference to FIG. 7 about a method for producing the protective sleeve for connecting the ferrules according to the present invention. In this embodiment, a sleeve, which is usable to connect ferrules having an outer diameter of 1.25 mm, is produced. As shown in FIG. 7(a), a core wire 50 is prepared, which is composed of a stainless steel (SUS) wire material with a length of 400 mm having a circular cross section with a diameter of 1.25 mm. V-shaped grooves 52a, 52b, 52c are formed at equal angle intervals of 120° about the center of the central axis AX of the core wire 50 on an outer circumferential surface 50a of the core wire 50 (FIG. 7(b)). Each of the grooves 52a, 52b, 52c has a tapered shape toward the central axis AX as viewed in a circular cross section of the core wire 50. Each of the grooves 52a, 52b, 52c was formed so that the depth was about 1 mm from the outer circumferential surface of the core wire 50, and the open angle of the taper was about 10°. A cutting tool was used to form the grooves. Subsequently, as shown in FIG. 7(c), the core wire 50, which served as an electrode when the electroforming method was used, was immersed in a nickel ion-based electroforming solution. The nickel 53 was deposited (sedimented) until the thickness was about 0.5 mm on the outer circumferential surface 50a of the core wire 50 while effecting the rotation about the center of the axis AX. After taking out the core wire 50 from the electroforming solution, the outer circumferential surface of the deposited nickel 53 was polished with a grinding stone (or a polishing machine) so that the outer diameter was 3.25 mm. Subsequently, the core wire 50 was extracted in the direction of the axis AX by using a gripping tool such as pincers while holding the nickel 53. Accordingly, the protective sleeve 54 as shown in FIG. 7(d) was obtained.

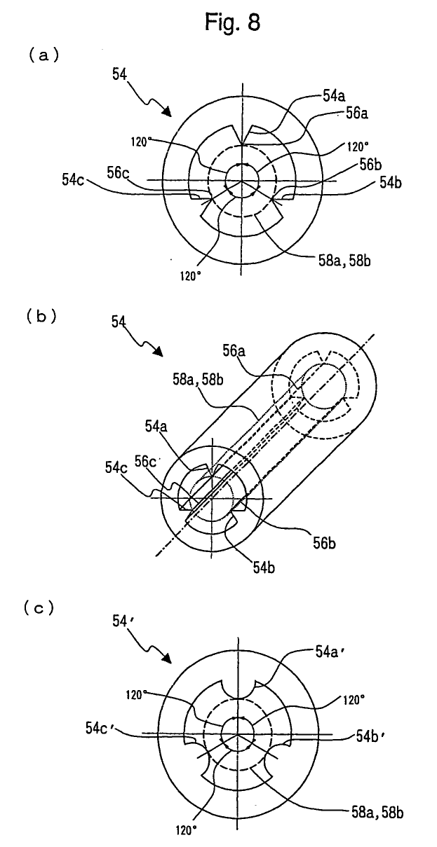

As shown in FIG. 8(a), the protective sleeve 54, which is manufactured in accordance with the method as described above, is formed to have a cylindrical shape with an outer diameter of 3.25 mm and an inner diameter of 2.25 mm about the center of the same axis AX as that of the core wire 50. Three inverted V-shaped projections (projections 54a, 54b, 54c), which have a height of 0.5 mm and which maintain the equal angle intervals of 120° about the center of the axis AX corresponding to the V-shaped groove portions formed on the circumferential surface 50a of the core wire 50, are formed at inner diametral portions of the protective sleeve 54. As shown in FIG. 8(b), the projections 54a, 54b, 54c are formed from one end surface to the other end surface of the cylindrical sleeve 54 so that respective tips 56a, 56b, 56c of the projections 54a, 54b, 54c are in parallel to the axis AX. The height of each of the projections 54a, 54b, 54c (distance from the outer circumferential surface of the sleeve 54 to the tip 56a, 56b, 56c) had an accuracy of 1.25 mm±0.1 μm in the axial direction of the sleeve 54. When the ferrules 58a, 58b having the outer diameter of 1.25 mm are fitted into the protective sleeve 54 formed as described above, the outer circumferential surfaces of the ferrules 58a, 58b are supported by the tips 56a, 56b, 56c over the entire length of the protective sleeve 54 respectively. Therefore, the positions (coaxiality) of the ferrules 58a, 58b in the sleeve 54 are maintained extremely highly accurately. When the protective sleeve 54 is viewed in a cross section perpendicular to the axis AX, the outer circumferential surfaces of the ferrules 58a, 58b make the point-to-point contact with the three points of the tips 56a, 56b, 56c of the protective sleeve 54.

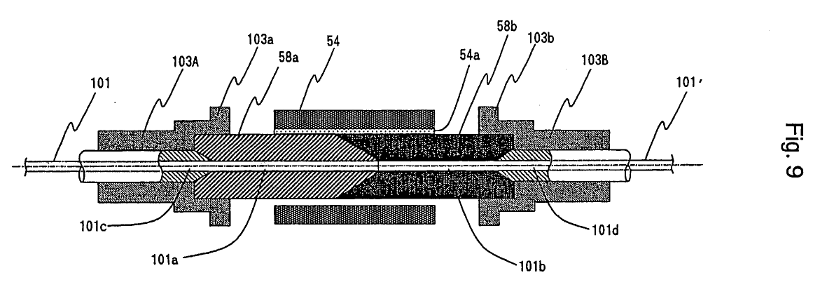

Next, FIG. 9 shows an example of the ferrule connecting form based on the use of the protective sleeve 54 manufactured in this embodiment. The embodiment shown in FIG. 9 was constructed in the same manner as in the first embodiment except that the protective sleeve 54 was used in order to improve the coaxial accuracy for the connected two ferrules 58a, 58b. As described above, the heights of the projections of the protective sleeve 54 are extremely uniform among the respective projections in the axial direction of the respective projections. Therefore, the ferrules 58a, 58b, which have the same outer diameter, are positioned coaxially in the protective sleeve 54. Further, the protective sleeve 54 is cylindrical with no split. Therefore, the elastic deformation of the protective sleeve 54 itself is scarcely caused. In particular, the ferrules are supported by the tips of the projections of the protective sleeve 54. Therefore, even if any elastic deformation occurs on the inner surface of the protective sleeve 54, the influence of the elastic deformation is decreased as compared with a case in which the ferrules are supported by making the contact with the entire inner surface of the sleeve. Therefore, the axial adjustment accuracy between the optical fiber-inserting holes 101a, 101b in the ferrules 58a, 58b is improved as compared with the first embodiment. Therefore, the axial adjustment accuracy between the optical fiber 101 or 101′ inserted into the ferrules 58a, 58b is further improved as well. Accordingly, the light can be transmitted in a well-suited manner between the connected optical fibers.

In the embodiment described above, each of the projections 54a, 54b, 54c of the protective sleeve 54 is formed to have the inverted V-shaped form. However, as shown in FIG. 8(c), the projection may be formed to have a circular arc-shaped form provided that the fitted ferrules 58a, 58b can be supported in accordance with the point-to-point contact (projections 54a′, 54b′, 54c′). In the embodiment described above, the three projections are formed at the equal angle intervals with respect to the inner diameter of the protective sleeve. However, for example, four, five, or six of the projections may be formed at equal angle intervals. In the embodiment described above, the protective sleeve is obtained by extracting the core wire by using a gripping tool such as pincers while retaining the nickel. However, the core wire can be also extruded from the nickel by bringing a pressurized fluid at a high pressure into contact with the end of the core wire in place of the gripping tool. This procedure is especially effective when the ferrules are mass-produced.

### INDUSTRIAL APPLICABILITY

As described above, according to the present invention, the coupling can be performed easily and reliably at the coupling section between the ends of the optical fibers.

That is, the conical male convex structure, which is disposed at the front section of one-ferrule, is fitted and inserted correctly, smoothly, and easily into the conical female concave structure disposed at the front section of the other ferrule as if the male convex structure automatically searches for the identical axis in accordance with the guiding action to make the abutment.

When the ferrule manufactured by the electroforming method is used, it is possible to provide the ferrule having the shape of the present invention which has the linear thin hole having the high circularity with the length of not less than 8 mm and the inner diameter of not more than 125 μm.

The two ferrules can be connected to one another in accordance with the highly accurate axial adjustment by using the protective sleeve of the present invention. Accordingly, it is possible to obtain the reliable light transmission.

1. A pair of ferrules used for an optical fiber connector, the pair of ferrules comprising:
a first ferrule which has an optical fiber-inserting hole; and
a second ferrule which has an optical fiber-inserting hole and which is arranged opposingly to the first ferrule so that the optical fiber-inserting hole of the second ferrule is positioned coaxially with respect to the optical fiber-inserting hole of the first ferrule, wherein:
an end of the first ferrule, which is opposed to the second ferrule, has a male convex shape, and an end of the second ferrule, which is opposed to the first ferrule, has a female concave shape provided with a fitting section for receiving the end having the male convex shape while making tight contact therewith.

2-19. (canceled)

20. The ferrules used for the optical fiber connector according to claim 1, wherein each of the end having the male convex shape and the end having the female concave shape has one of a conical shape, a spheroidal shape, and a hemispherical shape.

21. The ferrules used for the optical fiber connector according to claim 1, wherein the end having the male convex shape of the first ferrule is conical, and the cone has an angle of depression of 20° to 80°.

22. The ferrules used for the optical fiber connector according to claim 1, wherein each of the first and second ferrules is made of metal.

23. The ferrules used for the optical fiber connector according to claim 1, wherein each of the first and second ferrules is made of nickel alloy.

24. The ferrules used for the optical fiber connector according to claim 1, wherein each of the first and second ferrules is made of stainless steel.

25. The ferrules used for the optical fiber connector according to claim 1, wherein each of the first and second ferrules is produced by an electroforming method.

26. A pair of ferrules used for an optical fiber connector, the pair of ferrules comprising:
a first ferrule which has an optical fiber-inserting hole; and
a second ferrule which has an optical fiber-inserting hole and which is arranged opposingly to the first ferrule so that the optical fiber-inserting hole of the second ferrule is positioned coaxially with respect to the optical fiber-inserting hole of the first ferrule, wherein:
an end of the first ferrule, which is opposed to the second ferrule, has a male convex shape, an end of the second ferrule, which is opposed to the first ferrule, has a female concave shape provided with a fitting section for receiving the end having the male convex shape while making tight contact therewith, a base section of the end having the male convex shape is continued to an end edge of an annular step which is formed to have a diameter reduced in a radial direction of the ferrule, and a base section of the end having the female concave shape is continued to an end edge of an annular step which is formed to have a diameter reduced in a radial direction at an open end of the ferrule.

27. The ferrules used for the optical fiber connector according to claim 26, wherein each of the end having the male convex shape and the end having the female concave shape has one of a conical shape, a spheroidal shape, and a hemispherical shape.

28. The ferrules used for the optical fiber connector according to claim 26, wherein the end having the male convex shape of the first ferrule is conical, and the cone has an angle of depression of 20° to 80°.

29. The ferrules used for the optical fiber connector according to claim 26, wherein each of the first and second ferrules is made of metal.

30. The ferrules used for the optical fiber connector according to claim 26, wherein each of the first and second ferrules is made of nickel alloy.

31. The ferrules used for the optical fiber connector according to claim 26, wherein each of the first and second ferrules is made of stainless steel.

32. The ferrules used for the optical fiber connector according to claim 26, wherein each of the first and second ferrules is produced by an electroforming method.

33. An optical fiber connector structure comprising:
a first ferrule which has an optical fiber-inserting hole;
a second ferrule which has an optical fiber-inserting hole and which is arranged opposingly to the first ferrule so that the optical fiber-inserting hole of the second ferrule is positioned coaxially with respect to the optical fiber-inserting hole of the first ferrule;
a protective sleeve which covers the ferrules; and flange-equipped cylinders each of which has an optical fiber-introducing hole and each of which is provided and fitted on a proximal end side of each of the ferrules, wherein:
an end of the first ferrule, which is opposed to the second ferrule, has a male convex shape, and an end of the second ferrule, which is opposed to the first ferrule, has a female concave shape provided with a fitting section for receiving the end having the male convex shape while making tight contact therewith.

34. The optical fiber connector structure according to claim 33, wherein each of the first and second ferrules is produced by an electroforming method.

35. The optical fiber connector structure according to claim 33, wherein the protective sleeve includes:
a cylindrical sleeve main body; and
a plurality of projections which are provided on an inner circumferential surface of the main body and which support outer circumferential surfaces of the ferrules for the optical fiber, and
the plurality of projections are provided at positions of rotational symmetry with respect to a central axis of the sleeve main body and have an identical height.

36. A sleeve, for connecting two optical fiber ferrules therein, comprising:
a cylindrical sleeve main body; and
a plurality of projections which are provided on an inner circumferential surface of the main body and which support outer circumferential surfaces of the optical fiber ferrules, wherein:
the plurality of projections are provided at positions of rotational symmetry with respect to a central axis of the sleeve main body and have an identical height.

37. The sleeve according to claim 36, wherein the projection has a tapered shape toward the central axis of the sleeve main body.

38. The sleeve according to claim 36, wherein the sleeve is formed by electroforming.

39. The sleeve according to claim 36, wherein the projections extend in parallel to the central axis of the sleeve main body.

40. The sleeve according to claim 36, wherein three of the projections are formed at positions of rotational symmetry at intervals of 120°.

41. A method for producing the sleeve as defined in claim 36, comprising:
forming a plurality of cutouts at positions of rotational symmetry on an outer circumferential surface of a core wire, the plurality of cutouts extending in a longitudinal direction of the core wire;
forming a metal film by electroforming around the core wire formed with the plurality of cutouts; and
removing the core wire from the metal film.

42. The method for producing the sleeve according to claim 41, wherein the core wire is removed by extrusion or extraction.

43. The method for producing the sleeve according to claim 41, wherein the core wire is extruded from the metal film by bringing a pressurized fluid into contact with the metal film or the core wire.
